(19) United States
(12) Patent Application Publication
(10) Pub. No.: US 2008/0250337 A1
(43) Pub. Date: Oct. 9, 2008

(54) Identifying interesting locations based on commonalities in location based postings

(75) Inventors: Saija Lemmela, Helsinki (FI); Hannu J Korhonen, Kangasala (FI); Akos Vetek, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/784,086

(22) Filed: Apr. 5, 2007

(51) Int. Cl. G06F 3/048

(52) U.S. Cl. 715/764

(57) ABSTRACT

A method and system that identifies and presents information, which is common in various postings in an area, such as a neighborhood. If various geographically proximate postings contain the same salient word(s), the information is considered to be reliable and useful and it is presented to a user. The user is capable of viewing the postings in a form displayed over a map of an area. The user may view the posting information in different forms, and also perform searches for information and postings.

### FIELD OF THE INVENTION

This invention relates generally to displaying information. More specifically, this invention relates to presenting information regarding location based electronic postings.

### BACKGROUND OF THE INVENTION

Posting of electronic notes by individuals has increased in recent years. Posting generally involves a user creating an electronic note and placing it on some type of public-accessible data base. While postings can be created by many types of electronic input devices, postings by mobile terminals is proliferating. As mobile terminals are starting to come equipped with GPS (Global Positioning System) features, location based posting will become more prevalent. A location based posting is where a user creates and posts information about a location, typically about the user's present location. As more devices, tools and services start to enable location based postings, the amount of location based information will grow fast.

This location based posting information can be very helpful. Users can access and read postings specific to places they are at, such as attending an event or visiting a new place. Users will be able to find out what are the interesting areas from his/her point of view, why they are interesting, where are e.g. the interesting services, activities, and sights and what do other people think about all these. A user visiting a new area can find out timely and highly relevant information about the area. As an example, a user attending a sports event in a new city can try to track down information about places to eat near the stadium. The user would need to search location postings from some database, and find location posting provided by users previously in the area.

However, the amount of information and postings can be enormous. A user trying to sort through or filter a large number of postings for a city can have a difficult time finding the information they need for based on the location, and on the service or establishment they are investigating.

Presenting location based postings in a form related to a displayed map is one possibility in order to control the amount of data. One system, as presented by GeoNotes (http://geonotes.sics.se) contains information about postings and how they are presented on pie charts laying over the map view. Other techniques involve maps with tags to indicate interesting points. This technique is often employed by commercial producers of maps and tour guide products. However, these tags require information specifically prepared by organizations and properly referenced and tagged in order to work properly, rather than public location postings.

Further, the nature of postings makes it difficult to display such information on a map display. If all individual messages are presented on top of the map, the view would soon be crowded and the user unable to see the map. The user would also have difficulty sorting through and selecting particular relevant location postings.

### SUMMARY OF THE INVENTION

One aspect of the present invention relates to finding and presenting interesting locations utilizing location based posting, and includes a method that identifies and presents such information. According to one embodiment, information which is common in various postings in a geographic area can be identified and presented to the user in a helpful format. As an example, if various neighboring postings contain the same salient word(s), the information may be considered to be reliable and useful and it is presented to the user.

Location based posting services enable users to send public messages, which will appear in a certain geographical location. The user can filter postings based on criteria such as time or tags defined by users. Users usually see tagging as too tedious and tags are often missing, incorrect or misguiding. An embodiment of the present invention relates to automatically finding postings on the map view and identifying possible interesting areas on the map, without relying on tags set by other users.

An advantage of the present invention is a presentation of an easily understandable summary view of very meaningful/important/relevant information filtered out and presented to a user. This is especially helpful for mobile devices with small screens (visualization view point) The present invention is also helpful for aiding in directed exploration, and can help compensate for difficult or slow input methods on some mobile devices.

Another advantage of the invention is user being able to easily pinpoint locations, which are the most interesting from their point of view. The method also supports users in searching information about interesting places, services, areas and activities.

In a first embodiment, the present invention includes a method comprising identifying a plurality of postings for a geographic area, the postings including location information; scanning the plurality of postings for common words; and grouping into a group at least two postings of the plurality of postings based on the common words. It also includes creating display information based on the group, the display information created utilizing the location information for the at least two postings in the group, and also the common words of the group.

This embodiment further includes overlaying the display information on a map display, and displaying the display information and the map display simultaneously. The display information can include a shaped boundary that indicates an area of the map display related to the location information for the group. This shaped boundary may be created utilizing information regarding proximity of geographic locations for the at least two postings in the group, based on the location data for the at least two postings in the group The shaped boundary may be displayed in a color indicating further information regarding the group, for example indicating a quantitative measure of the postings in the group. The display information may also include a word selected from the common words.

The display information may include a plurality of shaped boundaries, each of the shaped boundaries indicating an area of the map display wherein a common word is present in a plurality of postings with location information proximate the area of the map display.

This embodiment may include receiving a request for further information regarding the group, for example a request to view at least one of the plurality of postings, or a request for a search for the common words. Such search may be performed by receiving a search expression and indicating matches to common words in the postings based on the search expression.

In another embodiment, an apparatus comprises a processor; and a memory coupled to the processor. The memory includes instructions, that, when provided to the processor cause the processor to carry out steps of identifying a plurality of postings for a geographic area, the postings including location information; scanning the plurality of postings for common words; and grouping into a group at least two postings of the plurality of postings based on the common words. Further steps include creating display information based on the group, the display information created utilizing the location information for the at least two postings in the group, and also the common words of the group.

Another embodiment includes an apparatus comprising a means for displaying information; means for receiving posting information, the posting information including location information; means for scanning the plurality of received postings for common words, and grouping into a group at least two postings of the plurality of received postings based on the common words. It further may include a means for creating display information based on the group and utilizing the location information for the at least two postings in the group, and also utilizing the common words of the group, the display information including a shaped boundary that indicates an area for a map display; means for combining the display information with map information, and displaying the combined display information and map information using the display means; and means for receiving input regarding the combined display information and the map information, and for providing further information based on the received input.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 shows a display of information as created by an illustrative embodiment of the present invention;

FIG. 2A-2B shows a different display for information according to an embodiment;

FIG. 3A-3C shows a display and illustrates a filtering technique according to an embodiment;

FIG. 4 is a flowchart of steps performed by an embodiment of the present invention;

FIG. 5 shows a mobile device that includes a display for use with an embodiment of the invention; and

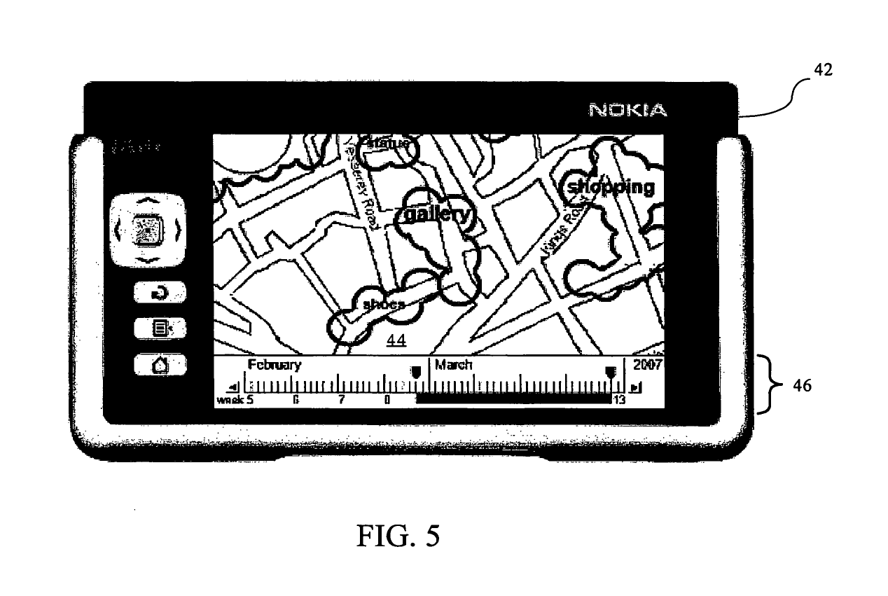

FIG. 6 a block diagram of components of a system for implementing an embodiment of the present invention.

### DETAILED DESCRIPTION OF THE INVENTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

The present invention includes a method that identifies and presents information which is common in various postings in a geographic area, such as a neighborhood. According to one embodiment, if various neighboring or geographically proximate postings include similar salient word(s), the information is presented to the user in a user-friendly format.

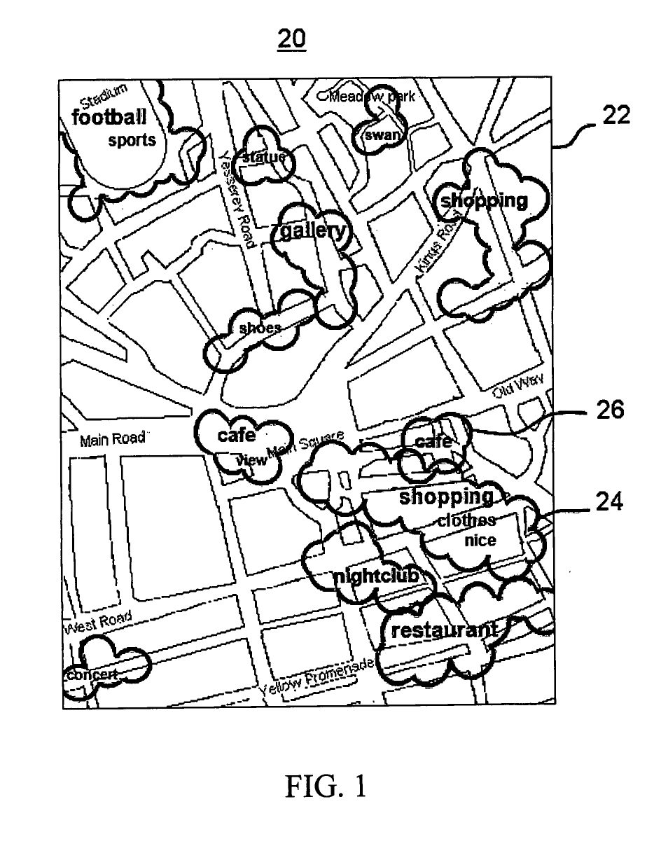

Different types of attractions, activities, services and events are typically situated in different parts of cities. Restaurants can be clustered along a certain street, one city district is specialized for antique shops and other for entertainment, while outdoor sports are mainly done near parks etc. FIG. 1 shows an example display according to one embodiment that helps present this information. A display 20 shows a map of an area of interest, for this example, a map of part of a city. To get an overall picture of the activities, services, sights and atmosphere of different city districts, the information of the most popular salient words used in public postings over the city can be presented to the user. This map may be based on a user's present location, for example if the user is visiting this particular city, and is searching for information and postings about places and activities proximate to the user. Alternatively, the user can view information and postings for far away locations, by selecting a map, or selecting a certain location on a map using a user interface device.

FIG. 1 shows this information in the form of information superimposed over a location map 22. This information may in the form a cloud 24 or 26. Based on location postings available, a cloud 24 may be placed, superimposed, or overlaid on to the map 22. This cloud 24 may indicate an area of interest based on the postings within this area. In the present example, this cloud 24 indicates an area with several shopping opportunities, such as a shopping district. Similarly, a cloud 26 indicating an area with one or more cafés may be placed over an area of the location map 22.

This type of display is sometimes referred to as a “heat map”, in which certain areas are colored based on the information being presented. In this embodiment, the information being presented is areas of interest as determined by location postings. Different colors (not shown) may be used based on type of interests (shopping, dining, events, sightseeing etc.), price ranges, or by density of location postings. Other examples of what colors may represent include types or interests of posting senders (or typical readers), for example tourists, teenagers, bird watches, etc. Similarly, the shape or shading of clouds may be altered to convey different information.

Words may be placed proximate with or superimposed over the clouds 24, 26 which describe items of interest for that area on the map. In one embodiment these words are selected from the location postings for that area, the words can express a common theme, or salient words, for the postings. For the shopping area of Cloud 24, the words “Shopping” “clothes” and “nice” are displayed. The words may be presented in different fonts, colors or sizes to indicate different information. In this example, the word “Shopping” is larger because it is a common term found in many of the location postings for this area. Alternatively, words may be presented in larger size or other distinguishing format based on the words being a salient word such as “Shopping” or “Nightclub”.

The embodiment may also use icons or graphics instead of words to label certain areas. This may take up less real estate on a display, as well as help with language issues. Icons may also be used to as a meta-category, such as a food icon may be displayed at all clusters that have a certain a level of postings regarding places to eat, even if the underlying salient words do not all match, but do fit into a general category of places to eat.

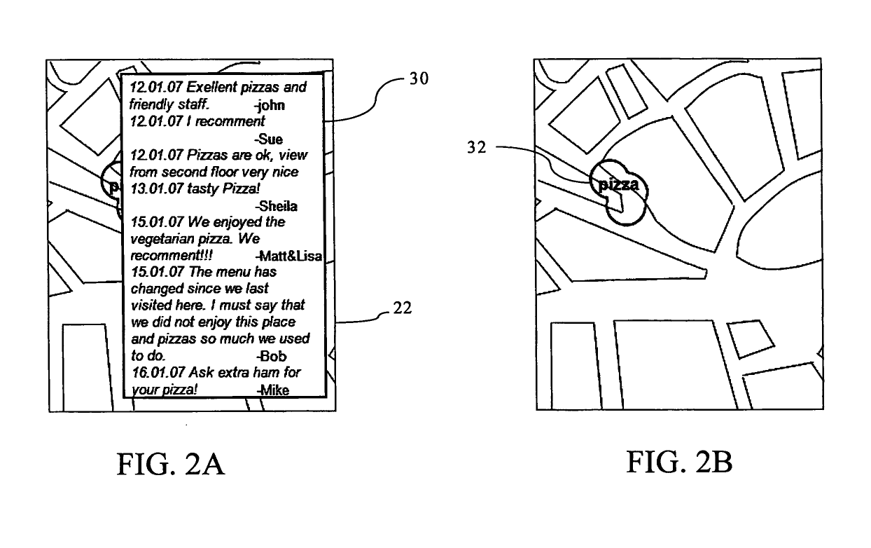

FIG. 2A shows a further example according to an embodiment of the present invention. Many closely situated public postings 30 are examined based on the words within them, typically with particular emphasis on salient words. Here, many neighboring postings include the word ‘pizza’ (or some synonym). This embodiment may present the information to the user in the form of a cloud 32 as shown in FIG. 2B representing the posting cluster, using a keyword overlaid on top. Users may switch back and forth between different views, for example by selecting the cloud 32 using any selection method provided by the user interface, in order to then see the locations postings 30 as shown in FIG. 2A. Users may switch between views for an entire display 20, or for selected areas.

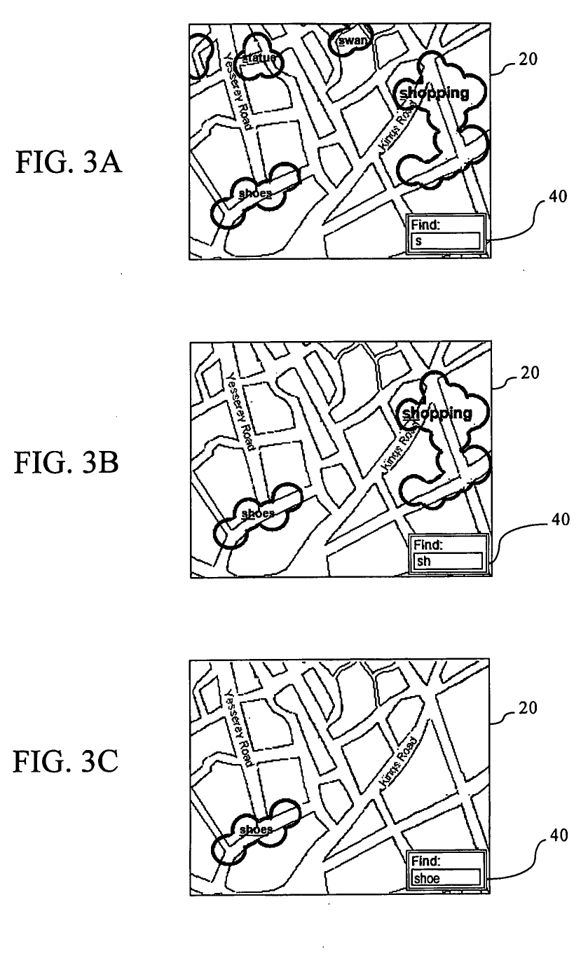

An example of a search technique according to one embodiment is shown in FIGS. 3A-3C. When a user tries to find a certain type of place or service from a city, he or she may type search words in a search box 40 and information about clouds (or individual postings) including these words can be displayed to them on the display 20. In this example, an incremental search routine is presented, allowing the user to see potential matches on the location view as the user enters characters. In FIG. 3A, there are many potential matches that include an ‘s’ character, and they are indicated by underlining. As further characters are entered, the potential matches decrease, FIG. 3B. When the user has typed enough of word ‘shoe’, there is one match on the display, as shown in FIG. 3C. Other search techniques are possible, including pull-down lists or other presentations of salient words or word groups for a particular area.

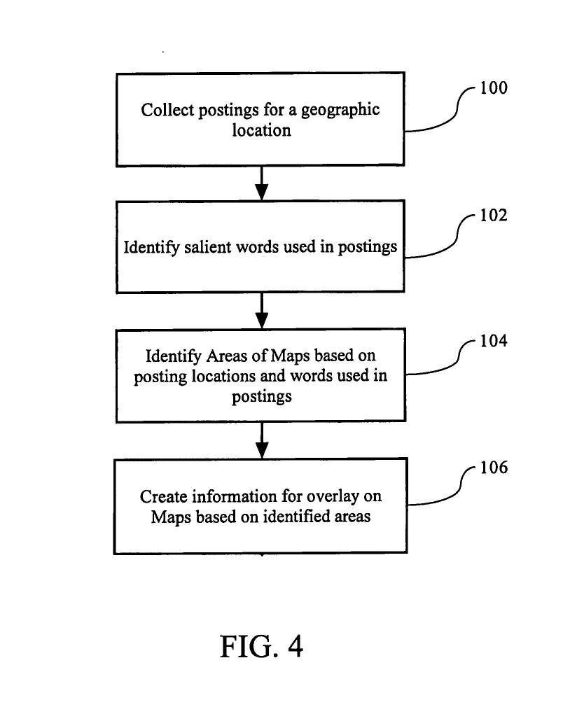

Steps for implementing an embodiment of the present invention are shown in FIG. 4. A system accesses a collection of location postings, step 100. Such location postings include an indication of the location for the posting. In some cases, the user may manually enter the location (using coordinates, map sectors, street names etc.). However, when the posting is created by a mobile terminal, the location posting may automatically include the location of the mobile terminal at the time the posting was created or posted. Such location data would be obtained from a GPS (Global Positioning System) device, although other means of automatically determining location, such as inertial sensors, LORAN systems, proximity detectors etc. are also possible. In a typical scenario, a user created the posting while at the location (for example sitting in the pizza place), and the location posting will include the location data from a GPS system in the poster's mobile terminal. Alternatively, the system can allow a user to use the mobile terminal to record his or her location at the time, and then later complete the posting message and match it with the location coordinates.

The collection of postings (or a subset thereof) are then scanned to determine common or salient words within the postings, step 102. Salient words may be determined based on pre-selected words such as restaurant, food etc., or based on the frequency with which the words appear in the postings. Synonyms and common abbreviations may also be considered. Further, using spell checking techniques may be employed to identify misspelled salient words.

The proximity of postings is also determined, step 104. In one embodiment, the clustering of location postings is considered important, and a standard K-means clustering algorithm may be employed. Typically a modified version of the K-means clustering algorithm would be employed with a suitably defined similarity measure taking into account both the similarity between the postings (by salient words or some other measure) and the geographic distance. In other embodiments, other methods may utilize ontologies, common-sense knowledge sources, calculating “semantic distances” between words and phrases, or given sufficient amounts of data, unsupervised learning methods like self-organizing maps (SOM). In another embodiment, if a user defines keywords s/he is interested in (by using search, favorite keywords etc.), the present invention can calculate the density of messages containing the word around the city, and then visualize to the user the locations where the density is above certain level.

Once the location postings are grouped, information may be created for display to a user, step 106. In this embodiment, overlay graphic information is created to be displayed in proper coordinates over a map display. The map display and overlaid graphic information typically will be coordinated to allow a person to scroll or resize the map display and have the overlay graphics be re-calculated (if necessary) and re-displayed to match the updated map display. The graphic information may include user interface features, such as being selectable by a user, for example, when a user selects a cloud 32 as shown in FIG. 2B to then view the collections of postings 30 shown in FIG. 2A that are related to that cloud 32. Visualization techniques for creating suitable graphic information includes for example Unified Distance Matrix (U-matrix) and/or 2D (or 3D) surface plots. As another example, the visualization or cloud enclosed is based on the algorithm that the place (x,y) is within a cloud if the distance to the nearest message (in the cluster) containing the word is less than, for example, 20 meters.

At any stage of processing, the system may sort or filter the collection of location postings. For example, postings older than a certain date may be excluded from any processing. Alternatively, the user may be provided with options for selecting or adjusting a time range for postings. The user can freely select a starting and ending time defining a time period. The display may be dynamically changed and updated as the user changes parameters.

The present invention may be implemented on a server that accesses and processes the location postings in order to create information that can then be provided to users through any standard display device, such as web browser, mobile terminal, PDA, or even printed out. Alternatively, a mobile terminal may be provided with an ability to receive some defined collection of location postings, and perform all the steps for processing to create information displayed on the mobile terminal.

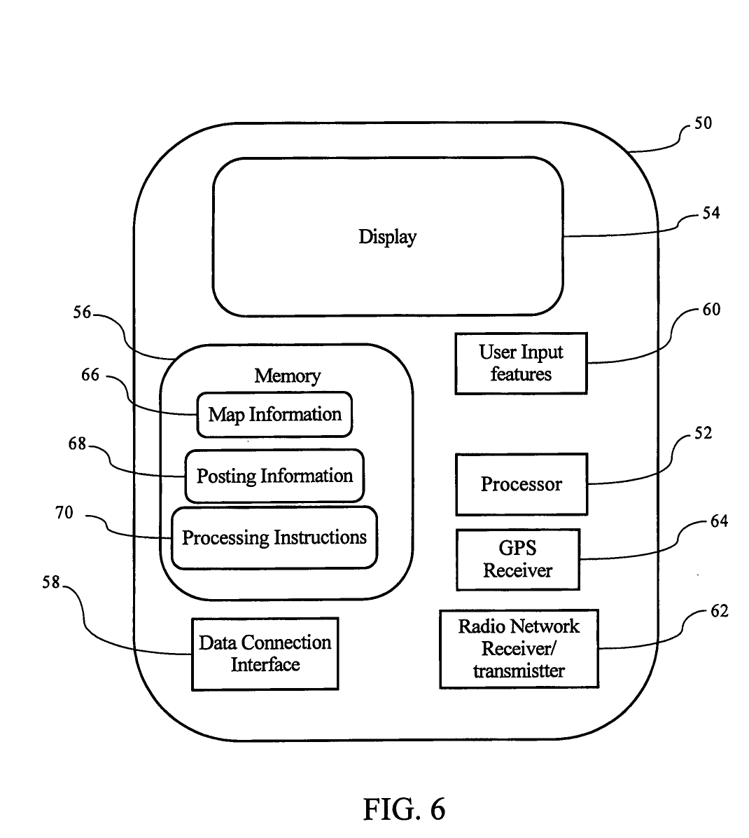

An embodiment of the present invention may be implemented on a mobile terminal such as a Nokia 770 internet tablet 42 shown in FIG. 6. This embodiment shows a map with information according to the present invention, and a timeline 46 to allow users to adjust the time window and immediately view the results. By using the timeline 46 the user can filter the posting clusters presented on a map view 44. The user can freely select the starting and ending times defining the interesting time period. In the example shown in FIG. 6, a user has selected a time window from late February to late March, and the display 44 utilizes postings within that time window to create the display information. Multiple time windows are also possible. The display of postings may be continuously updated based on selected time period: if the posting is sent during selected a time period, it is taken account in the display.

A system for implementing an embodiment of the present invention is shown in FIG. 6 with reference to a mobile device 50. Mobile device 50 may comprise a network-enabled wireless device, such as a digital camera, a cellular phone, a mobile terminal, a data terminal, a pager, a laptop computer or combinations thereof, which can access Internet applications that include location postings and other information. The mobile device may also comprise a device that is not network-enabled, such as a personal digital assistant (PDA), a wristwatch, a GPS receiver, a portable navigation device, a car navigation device, a portable TV device, a portable video device, a portable audio device, or combinations thereof. Such non network-enabled devices may include RFID tag readers. Further, the mobile device may comprise any combination of network-enabled wireless devices and non network-enabled devices. Although device 50 is shown as a mobile device, it is understood that the invention may be practiced using non-portable or non-movable devices. As a network-enabled device, mobile device 50 may communicate over a radio link to a wireless network (not shown) and through gateways and web servers. Examples of wireless networks include third-generation (3G) cellular data communications networks, Global System for Mobile communications networks (GSM), WLAN networks, or other wireless communication networks. Mobile device 50 may also communicate with a web server one or more ports (not shown) on the mobile device that may allow a wired connection to the Internet, such as universal serial bus (USB) connection, and/or via a short-range wireless connection (not shown), such as a BLUETOOTH™ link or a wireless connection to WLAN access point. Thus, mobile device 50 may be able to communicate with a web server in multiple ways.

As shown in FIG. 6, the mobile device 50 may include a processor 52, a display 54, memory 56, a data connection interface 58, and user input features 60, such as keypads, touch screens etc. It may also include a short-range radio transmitter/receiver 62, a global positioning system (GPS) receiver 64 and possibly other sensors (not shown). The processor 52 is in communication with memory 56 and performs instructions stored therein. The processor 52 is connected to display 54 and generates a display thereon, such as maps other displays. The user input features 60 are also in communication with the processor 52 for providing inputs to the processor. In combination, the user input 60, display 54 and processor 52, in concert with instructions stored in memory 56, generally form a graphical user interface (GUI), which allows a user to interact with the device and modify displays shown on display 54. Data connection interface 58 is connected to processor 52 and enables communication with wireless networks as previously described.

Short-range radio transmitter/receiver 62 is connected to processor 52 and enables communication via short-range radio communications, such as communications via a BLUETOOTH™ link or communications with radio frequency identification (RFID) tags. GPS receiver 64 receives GPS transmissions and communicates with processor 52 to enable the processor to determine current location information for mobile device 50. Mobile device 50 may also take advantage of other positioning mechanisms, such as positioning methods based on communication signals between the mobile device and base stations (e.g., triangulation methods) and proximity based methods (e.g., communication with a BLUETOOTH proximity sensor). Other sensors may be included in mobile device 50, such as accelerometers, cameras, thermometers, microphones, compass, etc. that can provide context information for the mobile device. For instance, accelerometers or a compass within mobile device 50 may provide information in concert with GPS receiver 64 to assist with providing real-time map updates to the user based on user movements along a route. Overall, mobile device 50 is generally a mobile computing device, such as a handheld personal computer, a mobile communication device, and a mobile terminal, that may include a variety of internal components, communication hardware and software, attachments, and the like.

In accordance with instructions in memory 56, the processor performs steps for displaying map information and location postings information in accordance with an embodiment. Memory 56 may include map information 66, which may be downloaded from a network as needed, or supplied with the mobile device 50. The memory 56 may also include posting information 68, which may include raw location posting information received from a network, or any type of processed information. For example, as previously discussed a server on a network may pre-process the location posting information and then provide that to the mobile device 50.

Also included in the memory 56 are processing instructions for performing the present invention. These processing instructions will display the map information 66, prepare and display overlay information derived from the posting information 68, and interact with the user. Such processing instructions may be stored in different types of memory, and may be downloaded or updated through an available network.

Additionally, the methods and features recited herein may further be implemented through any number of computer readable mediums that are able to store computer readable instructions. Examples of computer readable media that may be used include RAM, ROM, EEPROM, flash memory or other memory technology, CD-ROM, DVD or other optical disk storage, magnetic cassettes, magnetic tape, magnetic storage and the like.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

I/We claim:

1. A method comprising:
identifying a plurality of postings for a geographic area, said postings including location information;
scanning said plurality of postings for common words;
grouping into a group at least two postings of said plurality of postings based on said common words; and
creating display information based on said group, said display information created utilizing said location information for said at least two postings in said group, and also said common words of said group.

2. The method of claim 1 further including overlaying said display information on a map display, and displaying said display information and said map display simultaneously.

3. The method of claim 2 wherein said display information includes a shaped boundary that indicates an area of said map display related to said location information for said group.

4. The method of claim 3 wherein said shaped boundary is created utilizing information regarding proximity of geographic locations for said at least two postings in said group, based on said location data for said at least two postings in said group.

5. The method of claim 3 wherein said display information includes a word selected from said common words.

6. The method of claim 5 further including receiving input requesting a search for said common words.

7. The method of claim 3 wherein said shaped boundary is displayed in a color indicating further information regarding said group.

8. The method of claim 7 wherein said further information regarding said group includes a quantitative measure of said postings in said group.

9. The method of claim 2 wherein said display information includes a plurality of shaped boundaries, each of said shaped boundaries indicating an area of said map display wherein a common word is present in a plurality of postings with location information proximate said area of said map display.

10. The method of claim 2 further including receiving a request for further information regarding said group.

11. The method of claim 10 wherein said further information includes viewing at least one of said plurality of postings.

12. The method of claim 10 further including receiving a search expression and indicating matches to common words in said postings based on said search expression.

13. Apparatus comprising:
a processor;
a memory, coupled to said processor, said memory including instructions, that, when provided to said processor cause said processor to carry out steps of:
identifying a plurality of postings for a geographic area, said postings including location information;
scanning said plurality of postings for common words;
grouping into a group at least two postings of said plurality of postings based on said common words; and
creating display information based on said group, said display information created utilizing said location information for said at least two postings in said group, and also said common words of said group.

14. The apparatus of claim 13 wherein said step of creating display information includes overlaying said display information on a map display, and displaying said display information and said map display simultaneously.

15. The apparatus of claim 14 wherein said display information includes a shaped boundary that indicates an area of said map display related to said location information for said group.

16. The apparatus of claim 15 wherein said shaped boundary is created utilizing information regarding proximity of geographic locations for said at least two postings in said group, based on said location data for said at least two postings in said group.

17. The apparatus of claim 15 wherein said display information includes a word selected from said common words.

18. The apparatus of claim 17 wherein said steps include receiving input to allow a search for said common words.

19. The apparatus of claim 15 wherein said shaped boundary is displayed in a color indicating further information regarding said group.

20. The apparatus of claim 19 wherein said further information regarding said group includes a quantitative measure of said postings in said group.

21. The apparatus of claim 14 wherein said display information includes a plurality of shaped boundaries, each of said shaped boundaries indicating an area of said map display wherein a common word is present in a plurality of postings with location information proximate said area of said map display.

22. The apparatus of claim 14 wherein said steps include receiving a request for further information regarding said group.

23. The apparatus of claim 22 wherein said further information includes viewing at least one of said plurality of postings.

24. The apparatus of claim 22 wherein said steps include receiving a search expression and indicating matches to common words in said postings based on said search expression.

25. A machine-readable medium having machine-executable instructions for performing steps comprising:
identifying a plurality of postings for a geographic area, said postings including location information;
scanning said plurality of postings for common words;
grouping into a group at least two postings of said plurality of postings based on said common words; and
creating display information based on said group, said display information created utilizing said location information for said at least two postings in said group, and also said common words of said group.

26. An apparatus comprising:
means for displaying information;
means for receiving posting information, said posting information including location information;
means for scanning said plurality of received postings for common words, and grouping into a group at least two postings of said plurality of received postings based on said common words;
means for creating display information based on said group and utilizing said location information for said at least two postings in said group, and also utilizing said common words of said group, said display information including a shaped boundary that indicates an area for a map display;
means for combining said display information with map information, and displaying said combined display information and map information using said display means;
means for receiving input regarding said combined display information and said map information, and for providing further information based on said received input.

27. A mobile device comprising:
a display component;
a processing component, coupled to said display component;
a memory component, coupled to said processing component;
a radio receiving component, to receive a plurality of postings from a radio network, said postings including location information, wherein said postings are stored in said memory component;
wherein said memory component includes map information and also instructions, that when provided to said processing component, cause said processing component to perform the steps of:
scanning said plurality of received postings for common words;
grouping into a group at least two postings of said plurality of received postings based on said common words;
creating display information based on said group, said display information created utilizing said location information for said at least two postings in said group, and also said common words of said group, said display information including a shaped boundary that indicates an area for a map display;
combining said display information with said map information;
displaying said combined display information and map information on said display component; and
a user input component, to receive input regarding said display information on said display component.
